(19) United States
(12) Patent Application Publication
(10) Pub. No.: US 2025/0202297 A1
(43) Pub. Date: Jun. 19, 2025

(54) MOTOR AND A MOBILITY VEHICLE INCLUDING THE SAME

(71) Applicants: HYUNDAI MOTOR COMPANY, Seoul (KR); KIA CORPORATION, Seoul (KR)

(72) Inventors: Hyung Kwan Jang, Uijeongbu-si (KR); Hoo Dam Lee, Seoul (KR); Kyung Sik Choi, Seoul (KR); Jun Hyeok Choi, Suwon-si (KR); Byung Ho Min, Suwon-si (KR); Tae Gyu Lee, Seoul (KR)

(73) Assignees: HYUNDAI MOTOR COMPANY, Seoul (KR); KIA CORPORATION, Seoul (KR)

(21) Appl. No.: 18/645,096

(22) Filed: Apr. 24, 2024

(30) Foreign Application Priority Data
Dec. 14, 2023 (KR) 10-2023-0181731

(51) Int. Cl. H02K 1/26; H02K 3/22; H02K 3/28; H02K 55/00

(52) U.S. Cl. CPC H02K 1/26; H02K 3/22; H02K 3/28; H02K 55/00; H02K 2213/03

(57) ABSTRACT

A motor includes a stator including a plurality of stator coils repeatedly arranged in a circumferential direction. The motor also includes a rotor provided inside the stator to be rotatable about a rotating shaft. The rotor includes a plurality of rotor coils interacting with the plurality of stator coils to generate rotational force. The plurality of the rotor coils are repeatedly arranged in the circumferential direction and are paired in twos to implement an N-pole or an S-pole.

### CROSS-REFERENCE TO RELATED APPLICATIONS

This application claims the benefit of and priority to Korean Patent Application No. 10-2023-0181731 filed on Dec. 14, 2023 in the Korean Intellectual Property Office, the entire contents of which are hereby incorporated herein by reference.

### BACKGROUND

### 1. Field

The present disclosure relates to a motor and a mobility vehicle including the same.

### 2. Description of Related Art

In general, electric motors may be classified as direct current (DC) motors and alternating current (AC) motors depending on the power source used. AC motors may be classified as synchronous motors and induction motors depending on structures thereof. Synchronous motors have high efficiency and are easy to control, but are difficult to manufacture and relatively high in price. Induction motors have been widely used because they have a simple structure, are resistant to external shocks, and are inexpensive.

Recently, with increasing research and development of mobility vehicles using electricity as a driving source, demand for electric motors has significantly increased. Electric motors used as driving sources for mobility vehicles are usually high-speed and high-power motors.

Mobility vehicles, including hybrid electric vehicles, aerial mobility vehicle, etc., may be partially or entirely driven by motors rather than internal combustion engines. As a motor for mobility vehicles, interior permanent magnet synchronous motors (IPMSMs) with permanent magnets have been widely used. IPMSMs have high efficiency and power. However, wound field synchronous motors (WFSMs) have also come to prominence due to the advantages thereof of reducing the cost of rare earth materials used as permanent magnets and controlling a magnetic field of rotors with current.

However, the related art motors have limitations in increasing power cannot and meet requirements of increasingly high-performance mobility vehicles. Moreover, in the case of the WFSMs, it may be difficult to produce high power due to structural limitations.

### SUMMARY

An aspect of the present disclosure is to provide a structure of a motor capable of generating high torque by a simple structural change, while being a field-wound type motor in which a coil is provided on a rotor.

The purpose of the present disclosure is not limited to the purpose mentioned above. Other objects not mentioned herein should be more clearly understood by those having ordinary skill in the art from the description below.

According to an aspect of the present disclosure, a motor is provided that includes a stator having a plurality of stator coils repeatedly arranged in a circumferential direction. The motor also includes a rotor provided inside the stator to be rotatable about a rotating shaft. The rotor includes a plurality of rotor coils interacting with the plurality of stator coils to generate rotational force. The plurality of rotor coils are repeatedly arranged in the circumferential direction and are paired in twos to implement an N-pole or an S-pole.

The plurality of rotor coils may alternately implement N-poles and S-poles in the circumferential direction.

The plurality of rotor coils may include rotor coils formed from a superconducting wire.

The plurality of rotor coils may include rotor coils formed of copper or aluminum that is wound.

The plurality of rotor coil may include rotor coils that have a race-track shape.

The plurality of rotor coils may include rotor coils of a coreless type that are provided without a core.

Rotor coils of a pair of rotor coils implementing the N-pole or S-pole may be arranged in a ‘V’ shape so that ends thereof adjacent to a stator coil of the stator are opened.

An angle between extension lines of the pair of rotor coils arranged in the ‘V’ shape may be less than 90 degrees.

An angle between extension lines of the pair of rotor coils arranged in the ‘V’ shape may be 20 to 50 degrees.

When the motor is driven, respective currents flowing through rotor coil of the pair of rotor coils arranged in the ‘V’ shape may flow in opposite directions.

When the motor is driven, i) one current, among the respective currents flowing through the rotor coils of the pair rotor coils arranged in the ‘V’ shape, may flow from the rotating shaft toward the stator and ii) the other current, among the respective currents flowing through the rotor coils of the pair rotor coils arranged in the ‘V’ shape, may flow from the stator toward the rotating shaft.

According to another aspect of the present disclosure, a motor is provided that includes a stator and a rotor provided inside the stator to be rotatable about a rotating shaft. The rotor includes a plurality of rotor coils. Rotor coils, among the plurality of rotor coils, are inset type rotor coils inserted into the rotor. The plurality of rotor coils are repeatedly arranged in a circumferential direction. The plurality of rotor coils are paired in twos and are arranged in a ‘V’ shape so that ends thereof adjacent to a stator coil of the stator are opened to implement an N-pole or S-pole.

When the motor is driven, magnetic flux coming from the plurality of rotor coils paired in twos and arranged in the ‘V’ shape may be concentrated inwardly.

When the motor is driven, respective currents flowing through rotor coils of a pair of rotor coils arranged in the ‘V’ shape may be in opposite directions.

When the motor is driven, i) one current, among the respective current flowing through the rotor coils of the pair of rotor coils arranged in the ‘V’ shape, flows from the rotating shaft toward the stator and ii) the other current, among the respective currents flowing through the rotor coils of the pair of rotor coils arranged in the ‘V’ shape, flows from the stator toward the rotating shaft.

According to another aspect of the present disclosure, a mobility vehicle is provided that includes a body and at least one driving unit provided in the body. The mobility vehicle further includes a battery provided in the body. The mobility vehicle additionally includes a motor connected to the battery and providing driving force to the at least one driving unit. The motor includes a stator including a plurality of stator coils repeatedly arranged in a circumferential direction. The motor also includes a rotor provided inside the stator to be rotatable about a rotating shaft. The rotor includes a plurality of rotor coils interacting with the plurality of stator coils to generate rotational force. The plurality of the rotor coils are repeatedly arranged in the circumferential direction and are paired in twos to implement an N-pole or an S-pole.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a cross-sectional view of a motor, according to the related art;

FIG. 2 is a cross-sectional view of a motor, according to an embodiment of the present disclosure;

FIG. 3 is a cross-sectional view of a rotor, according to an embodiment of the present disclosure;

FIG. 4 is a reference diagram illustrating the principle of concentrating magnetic flux in a rotor, according to an embodiment of the present disclosure;

FIG. 5 is a reference diagram illustrating the principle based on which polarity is formed in a rotor, according to an embodiment of the present disclosure;

FIG. 6 is a reference diagram illustrating a racetrack-shaped rotor coil structure applied to a rotor, according to an embodiment of the present disclosure;

FIG. 7 is simulation result data illustrating a maximum air gap magnetic flux density of a motor, according to an embodiment of the present disclosure;

FIG. 8 is simulation result data illustrating a maximum air gap magnetic flux density of a motor, according to the related art;

FIG. 9 is a reference diagram illustrating comparison between the magnitudes of torques implemented in the motors illustrated in FIGS. 7 and 8;

FIG. 10 is a perspective view illustrating an example of a mobility vehicle, according to an embodiment of the present disclosure; and

FIGS. 11A and 11B are perspective view illustrating an example of a mobility vehicle, according to another embodiment of the present disclosure.

### DETAILED DESCRIPTION

While the present disclosure may be modified in various ways and take on various alternative forms, specific embodiments thereof are illustrated in the drawings and described in detail below. However, it should be understood that there is no intent to limit the present disclosure to the particular forms disclosed. On the contrary, the present disclosure covers all modifications, equivalents, and alternatives falling within the spirit and scope of the present disclosure.

It should be understood that, although the terms “first,” “second,” etc. may be used herein to describe various elements, these elements are not limited by these terms. These terms are only used to distinguish one element from another. For example, a first element could be termed a second element, and a second element could similarly be termed a first element, without departing from the scope of the present disclosure. As used herein, the term “and/or” includes any and all combinations of one or more of the associated listed items.

The terms such as “unit,” “part,” “portion,” etc. may be used to describe various components. However, the components are not limited by these terms. The above terms may refer to not only physically/visually distinct components, but also to functions or components of a portion even if the corresponding portion is not clearly divided.

The terms used herein to describe embodiments of the present disclosure are not intended to limit the scope of the present disclosure. The articles “a,” and “an” are singular in that they have a single referent. However the use of the singular form in the present document does not preclude the presence of more than one referent. In other words, elements of the present disclosure referred to in the singular may number one or more unless the context clearly indicates otherwise. It should be further understood that the terms “comprise,” “comprising,” “include,” or “including,” or the like, when used herein, specify the presence of stated features, numbers, steps, operations, elements, and/or components. The terms do not preclude the presence or addition of one or more other features, numbers, steps, operations, elements, components, and/or groups thereof.

Unless defined in a different way, all the terms used herein including technical and scientific terms have the same meaning as commonly understood by those having ordinary skill in the art to which the present disclosure pertains. Such terms as defined in generally used dictionaries should be construed to have the same or equivalent meaning that is consistent with their meaning in the contexts of the related art. The terms should not be construed to have ideally or excessively formal meaning unless clearly defined in the application.

When a component, device, element, or the like of the present disclosure is described as having a purpose or performing an operation, function, or the like, the component, device, or element should be considered herein as being “configured to” meet that purpose or perform that operation or function.

In various embodiments of the present disclosure, a mobility vehicle may be a device that moves in a space related to ground, underground, air, space, sea, and/or underwater, depending on the space in which the mobility vehicle moves. Mobility vehicles on the ground or underground may be provided in the form of, for example, vehicles, robots, etc. Mobility vehicles in the air or space, i.e., aerial mobility vehicles, may be provided in the form of, for example, typical fixed-wing or rotary-wing aircraft, advanced aerial mobility vehicles (AAMs), unmanned aerial vehicles or drones, rockets, units of transportation mounted on artificial satellites, or the like. A maritime or underwater mobility vehicle may be, for example, a ship, a submarine, or the like. The mobility vehicle may be not limited to a specific space. For example, the mobility vehicle may be a mobile body that may move between multiple spaces, such as a mobile body that may move through all of the aforementioned spaces. The mobility vehicle may be, for example, an amphibious vehicle, a flying vehicle, etc.

In the description below, the terms “anterior,” “posterior,” “lateral,” “front,” “rear,” “up/down,” “above,” “upper,” “top,” “below,” “lower,” “bottom,” “left/right,” etc. are defined based on a vehicle or a vehicle body. In addition, terms, such as first and second may be used to describe various components. However, these components should not be limited in order, size, location, or importance by terms, such as first and second. These terms are only used to distinguish one component from another.

Hereinafter, embodiments of the present disclosure are described in more detail with reference to the accompanying drawings.

As is well known, a motor typically includes a stator and a rotor. The rotor is configured to rotate due to electromagnetic interaction between the stator and the rotor. As previously introduced, motors include a permanent magnet synchronous motor (PMSM) in which a permanent magnet is used in a rotor or a wound field synchronous motor (WFSM) in which a field coil is wound around a rotor.

In the WFSM, coils are used instead of permanent magnets to create magnetic flux in the rotor. Specifically, field magnetic flux is generated by winding a coil around the teeth of the rotor. Typically, in the case of WFSM, a coil is wound around an electrical steel sheet, and field magnetic flux may be allowed to pass through an air gap via the electrical steel sheet. However, when manufacturing a field coil using a superconducting wire, core-type motors including an electrical steel sheet or coreless-type motors not including an electrical steel sheet may be used. The coreless-type motors may include non-magnetic materials instead of an electrical steel sheet. The coreless-type motors may include plastic, stainless steel, copper, aluminum, etc., as non-limiting examples of materials.

The air gap formed between the stator and the rotor in a motor has a significant impact on motor efficiency. In particular, a non-uniform effective air gap length may cause a low air gap magnetic flux density, which may decrease power.

Moreover, in the case of an inset type motor in which a coil or permanent magnet is inserted into a rotor, the rotor coil or permanent magnet may be further retreated toward a rotating shaft. Thus, a distance from a stator coil or permanent magnet may be increased to increase the length of a magnetic air gap, which may have a more significant effect on lowering power of the motor.

In particular, many of these problems may occur in the case of superconducting motors using a superconducting wire as the rotor coil. Superconducting motors are often manufactured in a structure in which a race-track shaped is provided on the rotor. In addition, the coil superconducting wire has restrictions on the degree of freedom of shape when coils are formed of a ceramic material. Further, a critical current value may be lowered as the wire is significantly deformed. However, in order to maximize power of the motor, the air gap magnetic flux density should be increased. In other words, as the field magnetic flux in the rotor region increases, motor power may increase.

However, superconducting motors are inset-type motors in which a coil or permanent magnet is inserted into the rotor in many cases. In this case, the magnetic air gap length is bound to be large and the magnetic flux transmitted to the air gap may also be weak.

Embodiments of the present disclosure increase the magnetic flux transmitted to the air gap, while a race-track shaped field coil is utilized in the rotor. In addition, the disclosed structure may increase the magnetic flux transmitted in the air gap direction by disposing the rotor coil in a magnetic flux concentration structure described in more detail below. The rotor coil may be formed of a superconducting wire or a material, such as highly conductive copper or aluminum. The rotor coil may be provided in a racetrack shape and inserted into the rotor. However, the present disclosure is not limited thereto. The rotor coil may be formed of various materials and may be provided in the rotor in various structures.

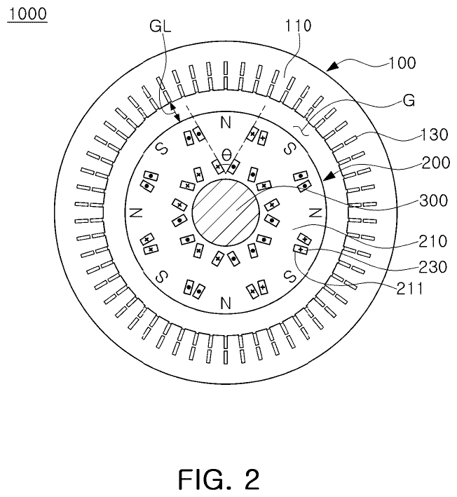

As illustrated in FIG. 2, a motor 1000 according to an embodiment of the present disclosure may include a stator 100 and a rotor 200. The rotor 200 is fixedly installed on a rotating shaft 300. The rotor 200 may rotate around the rotating shaft 300 together with the rotating shaft 300 inside the stator 100.

An air gap G may be provided between the stator 100 and the rotor 200 to facilitate rotation of the rotor 200. Accordingly, a magnetic air gap length GL may be formed between the stator 100 and the rotor 200. The magnetic air gap length GL may affect the performance of the motor.

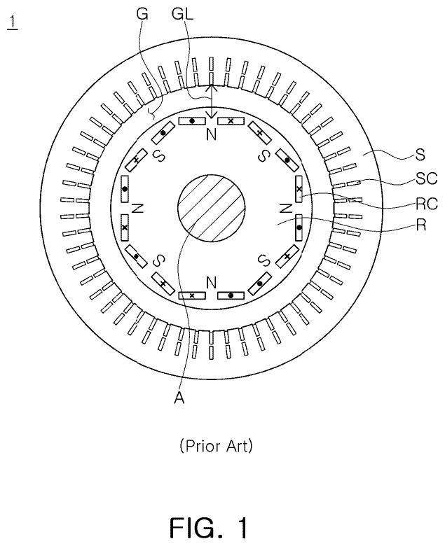

However, as illustrated in FIG. 1, a motor 1 according to the related art includes a stator S and a rotor R. The stator S includes a stator coil SC and the rotor R includes a rotor coil RC. Also, the rotor R rotates around a rotating shaft A. An air gap G is provided between the stator S and the rotor R. In this structure, there is a problem that, as a magnetic air gap length GL increases, magnetic flux transmitted to the air gap G may weaken. In particular, this problem may become worse in the case of an inset type in which the rotor coil RC is provided in the slot of the rotor.

Referring again to FIG. 2, the stator 100 may include a stator body 110 and a stator coil 130. The stator coil 130 may be wound around a core provided on the stator body 110. The stator coil 130 may be provided in plural and the plurality of stator coils 130 may be repeatedly arranged in a circumferential direction. Here, the circumferential direction may refer to a direction in which the rotor rotates.

In an embodiment, the stator coil 130 may be replaced with a permanent magnet. In addition, although not shown, the stator coil 130 may be formed of a separately provided steel plate or coreless body and installed on the stator body 110.

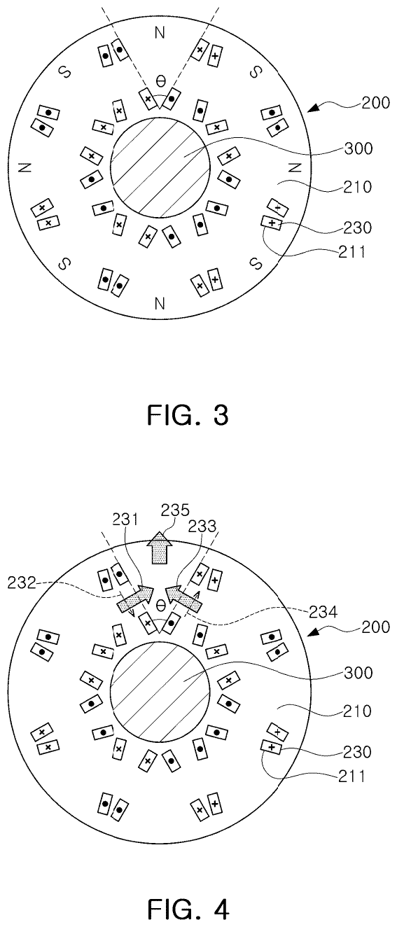

As illustrated in FIGS. 2-5, the rotor 200 may be fixedly installed on the rotating shaft 300, which is the center of rotation.

The rotor 200 may be rotatably provided inside the stator 100 about the rotating shaft 300. The rotor 200 may include a plurality of rotor coils 230 interacting with the stator coil 130 to generate rotational force.

The rotor coil 230 may be provided on the rotor body 210 fixed to the rotating shaft 300. The rotor coil 230 may be wound around a core (not shown) provided in the rotor body 210 or may be manufactured separately and installed on the rotor body 210. In an embodiment, the rotor coil 230 may include a plurality of rotor coils 230. The plurality of rotor coils 230 may be repeatedly arranged d in the circumferential direction to face the stator coil 130.

The rotor coil 230 may be a superconducting wire. However, the present disclosure is not limited. For example, the rotor coil 230 may be formed of a conductive material, such as copper or aluminum. The rotor coil 230 may be wound around a core. Alternatively, as illustrated in FIG. 6, the rotor coil 230 may be provided in a race-track shape, may have a core, or may be provided in a coreless shape without a core.

As illustrated of FIG. 2, the plurality of rotor coils 230 are repeatedly arranged in the circumferential direction and may be formed in pairs to implement an N-pole or an S-pole. The pair of rotor coils 230 implementing the N-pole or S-pole may be arranged in a ‘V’ shape so that the ends close to the stator coil 130 are opened.

Accordingly, the rotor coil 230 ultimately allows the N-pole and the S-pole to be implemented alternately in the circumferential direction. Further, since the rotor coils 230 implement a ‘V’ shaped magnetic concentration structure, the polarity may be formed more strongly. Thus, the rotor coils 230 may interact with the stator coil 130 to provide a motor generating greater torque.

More specifically, the plurality of rotor coils 230 may be implemented by alternating the N-poles and S-poles in the circumferential direction. In addition, the pair of rotor coils 230 implementing the N-pole or S-pole may be arranged in a ‘V’ shape so that the ends close to the stator coil 130 are opened.

An angle between extension lines of the rotor coil pair arranged in a ‘V’ shape may be less than 90 degrees. For example, the angle between the extension lines of the rotor coil pair arranged in a ‘V’ shape may be 20 to 50 degrees.

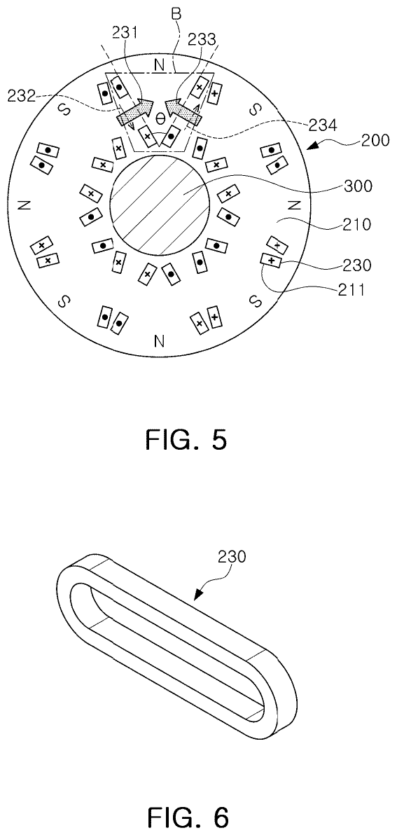

Referring now to FIG. 5, it can be seen that the rotor coil pair arranged in a ‘V’ shape implements a ‘V’ shaped magnetic concentration structure. Thus, polarity may be formed more strongly.

When the motor 1000 is driven, current flowing through the rotor coil 230, which are arranged in pairs in a ‘V’ shape, may flow in opposite directions. In other words, as for the current flowing through the rotor coils 230 that are arranged in pairs in a ‘V’ shape, when the motor is driven, any one current may flow from the rotating shaft 300 toward the stator 100 (as illustrated by an arrow 234 FIG. 5) and the other may flow from the stator 100 toward the rotating shaft 300.

Referring to FIG. 4, it can be seen that, when the motor 1000 is driven, magnetic flux generated from a pair of rotor coils 230 is concentrated inwardly. The magnetic fluxes 231 and 233 concentrated inwardly from both sides may be combined with each other (an effect of magnetic fluxes pushing each other), so that an increased magnetic flux 235 may be transmitted to the air gap G.

In other words, among the pair of rotor coils 230 arranged in a ‘V’ shape, when i) a direction of the current flowing in the left one is from the outside to the inside, i.e., the direction 232 from the stator to the rotating shaft, and ii) a direction of the current flowing in the right one is from the inside to the outside, i.e., in the direction 234 from the rotating shaft 300 to the stator, the magnetic fields may be formed in the directions respectively indicated by the arrows 231 and 233 according to Fleming's left-hand rule. Thus, the magnetic field may be formed inside the ‘V’ shape arrangement. Of course, the magnetic field may form the N-pole and the S-pole. The head of the arrows 231 and 233 may be the N-pole. Further, the opposite side, i.e., the tail of the arrows, may be the S-pole.

In addition, referring to FIG. 5, it can be seen that, when the motor 1000 is driven, the magnetic flux generated by the pair of rotor coils 230 is concentrated inwardly. The magnetic fluxes 231 and 233 concentrated inwardly from both sides may form an N-pole (the N-pole is formed on the left side perpendicular to the direction of current flow, and the S-pole is formed on the opposite side). The magnetic fluxes 231 and 233 concentrated inwardly from both sides may be combined together, and the increased magnetic flux 235 may be transmitted to the air gap G.

The other pair of rotor coils 230 adjacent to the square box portion (B) in FIG. 5 form an S-pole by forming a current flow opposite to that of the square box portion (in the drawing, current may flow from a point (·) to a point (X)).

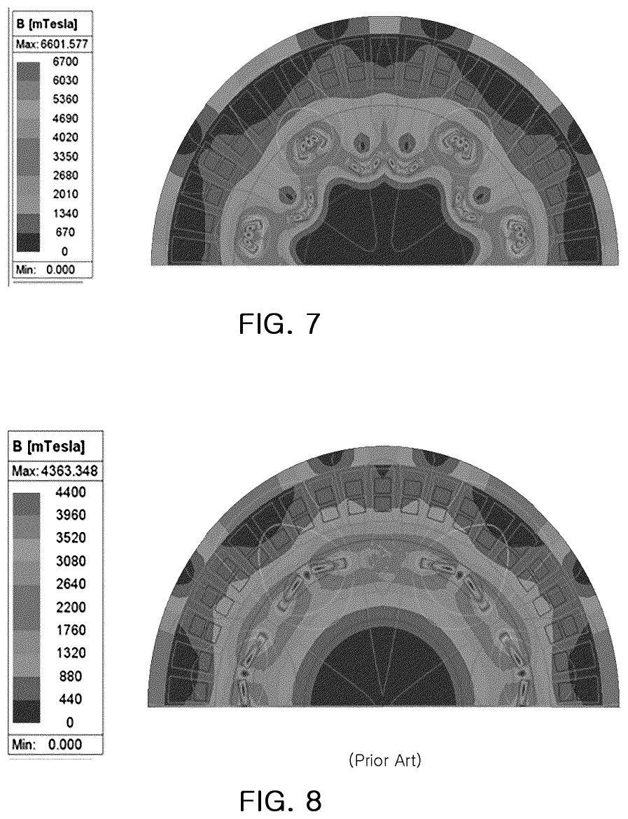

FIG. 7 shows simulation result data illustrating a maximum air gap magnetic flux density of the motor 1000, according to an embodiment of the present disclosure. FIG. 8 shows simulation result data illustrating a maximum air gap magnetic flux density of the motor 1 (the structure of FIG. 1), according to the related art.

As illustrated in FIG. 7, it can be seen that, in the motor 1000 according to embodiments of the present disclosure, the magnetic fluxes from the rotor coil are combined and the increased magnetic flux is transmitted to the air gap. Thus, the maximum air gap magnetic flux density is very large as about 2T. On the other hand, in the motor 1 having a general structure illustrated in FIG. 8, the maximum air gap magnetic flux density is about 1.7T.

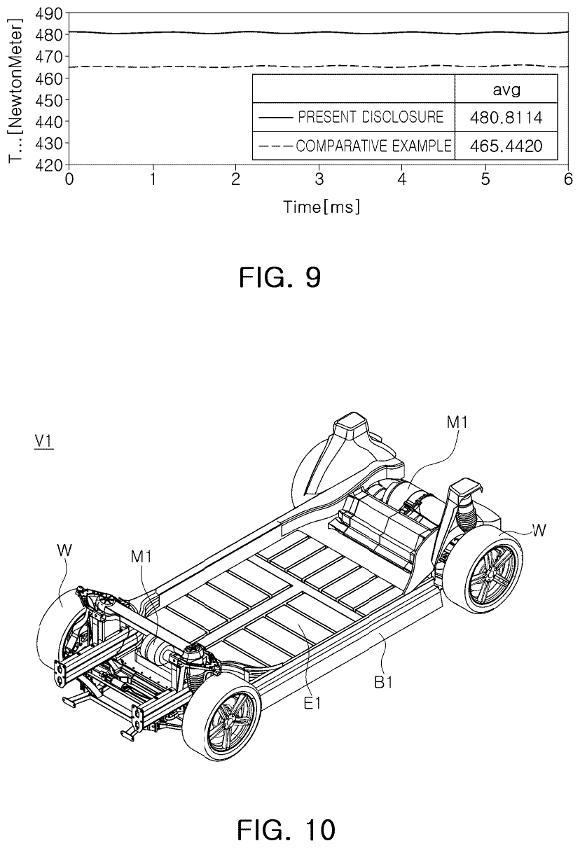

FIG. 9 is a reference diagram illustrating comparison between the magnitudes of torques implemented in the motors illustrated in FIGS. 7 and 8.

Referring to FIG. 9, it can be seen that, in motors in which all other conditions, such as superconducting coil usage and input current, are the same, the motor 1000 having a magnetic flux concentration structure provides a motor torque that is increased by about 3.3% as compared to the motor 1 of the related art.

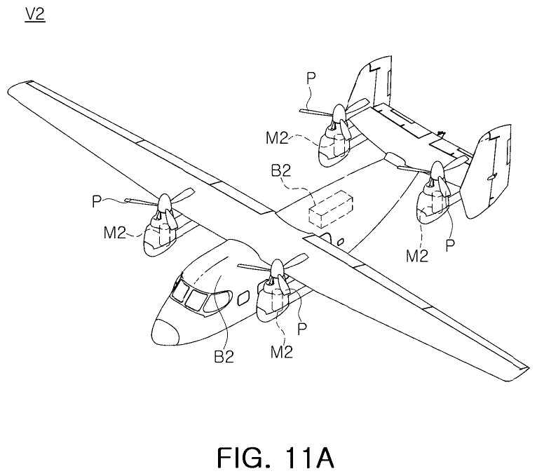

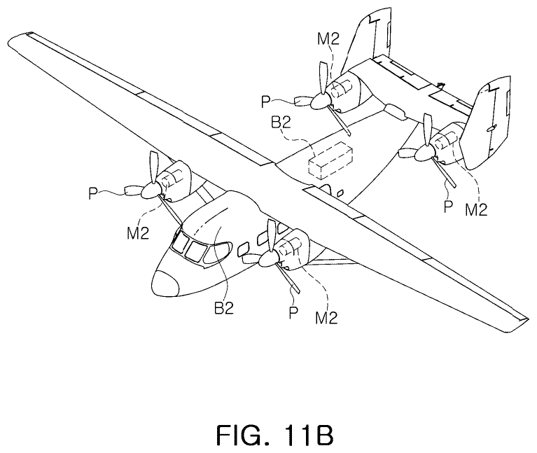

FIGS. 10, 11A, and 11B are perspective views illustrating example mobility vehicles in which a motor according to embodiments of the present disclosure may be used.

Mobility vehicles V1 and V2 according to embodiments of the present disclosure may include at least a body B1 and B2, driving units W and P provided in the bodies B1 and B2, motors M1 and M2 interworking with the driving units W and P, and batteries E1 and E2 providing power to the motors, respectively. The motors M1 and M2 installed in the mobility vehicles V1 and V2 according to embodiments of the present disclosure may be the motor 1000 described above with reference to FIGS. 1-9. Accordingly, a detailed description of the motors M1 and M2 has been omitted.

Referring to FIG. 10, the mobility vehicle V1 in an embodiment may be a vehicle that may move on the ground. The vehicle V1, which is a mobility vehicle, may include at least the body B1, a wheel W as a driving unit provided in the body B1, the motor M1 linked to the driving unit W, and the battery E1 providing power to the motor.

In addition, referring to FIGS. 11A and 11B, the mobility vehicle V2 in an embodiment may be an aerial mobility vehicle that moves in the air. The aerial mobility vehicle V2 of an embodiment may include at least a fuselage B2 as a body, a propulsion body (a propeller P) as a driving unit provided in the fuselage B2, the motor M2 linked to the propeller P, and the battery E2 providing power to the motor.

FIG. 11A illustrates a position of the propeller P when the aerial mobility vehicle V2 takes off or lands or hovers for turning at a specific point. FIG. 11B illustrates a position of the propeller P when the aerial mobility vehicle V2 moves in position (e.g., is driven). The aerial mobility vehicle V2 may have a structure in which a direction of the propeller P, which is a propulsion body of the aerial mobility vehicle V2, is tilted. Accordingly, the motor (e.g., the motor 1000) driving the propeller P may also be tilted.

In the case of a hovering mode illustrated in FIG. 11A, a main wing and/or tail wing tilting propeller P may be pivoted to be substantially perpendicular to the fuselage B2. In the case of a cruise mode illustrated in FIG. 11B, the main wing and/or tail wing non-tilting propeller P may be pivoted to be substantially parallel to the fuselage B2. The tilting of the main wing and/or tail wing propeller P may be synchronized depending on a flight mode. Further, the tilting of each propeller may be adjusted to be different depending on posture control and flight conditions in the same flight mode.

As described above, although specific illustrations may have been omitted, a mobility vehicle as used herein may be a device that moves through spaces related to the ground, underground, air, space, sea, and/or underwater, depending on the space in which the mobility vehicle moves.

A motor for a mobility vehicle according to embodiments of the present disclosure may generate high torque by simple structural change of a field-wound motor with a coil on a rotor.

A motor for a mobility vehicle according to embodiments of the present disclosure may be implemented by simple structural changes, so that performance may be improved without significant modification compared to the related art, thereby achieving the effect of substantially reducing costs.

While example embodiments have been illustrated and described above, it should be apparent to those having ordinary skill in the art that modifications and variations may be made without departing from the scope of the present disclosure as defined by the appended claims.

What is claimed is:

1. A motor comprising:
a stator including a plurality of stator coils repeatedly arranged in a circumferential direction; and
a rotor provided inside the stator to be rotatable about a rotating shaft, the rotor including a plurality of rotor coils interacting with the plurality of stator coils to generate rotational force,
wherein the plurality of the rotor coils are repeatedly arranged in the circumferential direction and are paired in twos to implement an N-pole or an S-pole.

2. The motor of claim 1, wherein the plurality of rotor coils alternately implement N-poles and S-poles in the circumferential direction.

3. The motor of claim 1, wherein the plurality of rotor coils includes rotor coils formed from a superconducting wire.

4. The motor of claim 1, wherein the plurality of rotor coils includes rotor coils formed from copper or aluminum that is wound.

5. The motor of claim 3, wherein the plurality of rotor coils include rotor coils that have a race-track shape.

6. The motor of claim 5, wherein the plurality of rotor coils includes rotor coils of a coreless type that are provided without a core.

7. The motor of claim 1, wherein rotor coils of a pair of rotor coils implementing the N-pole or S-pole are arranged in a ‘V’ shape so that ends thereof adjacent to a stator coil of the stator are opened.

8. The motor of claim 7, wherein an angle between extension lines of the pair of rotor coils arranged in the ‘V’ shape is less than 90 degrees.

9. The motor of claim 7, wherein an angle between extension lines of the pair of rotor coils arranged in the ‘V’ shape is 20 to 50 degrees.

10. The motor of claim 7, wherein, when the motor is driven, respective currents flowing through rotor coils of the pair of rotor coils arranged in the ‘V’ shape, are in opposite directions.

11. The motor of claim 10, wherein, when the motor is driven, i) one current, among the respective currents flowing through the rotor coils of the pair rotor coils arranged in the ‘V’ shape, flows from the rotating shaft toward the stator and ii) the other current, among the respective currents flowing through rotor coils of the pair of rotor coils arranged in the ‘V’ shape, flows from the stator toward the rotating shaft.

12. A motor comprising:
a stator; and
a rotor provided inside the stator to be rotatable about a rotating shaft, the rotor including a plurality of rotor coils,
wherein rotor coils, among the plurality of rotor coils, are inset type rotor coils inserted into the rotor, and
wherein the plurality of rotor coils are repeatedly arranged in a circumferential direction, and
wherein the plurality of rotor coils are paired in twos and are arranged in a ‘V’ shape so that ends thereof adjacent to a stator coil of the stator are opened to implement an N-pole or S-pole.

13. The motor of claim 12, wherein, when the motor is driven, magnetic flux coming from the plurality of rotor coils paired in twos and arranged in the ‘V’ shape is concentrated inwardly.

14. The motor of claim 12, wherein, when the motor is driven, respective currents flowing through rotor coils of a pair of rotor coils arranged in the ‘V’ shape are in opposite directions.

15. The motor of claim 14, wherein, when the motor is driven, i) one current, among the respective current flowing through the rotor coils of the pair of rotor coils arranged in the ‘V’ shape, flows from the rotating shaft toward the stator and ii) the other current, among the respective currents flowing through the rotor coils of the pair of rotor coils arranged in the ‘V’ shape, flows from the stator toward the rotating shaft.

16. A mobility vehicle comprising:
a body;
at least one driving unit provided in the body;
a battery provided in the body; and
a motor connected to the battery and providing driving force to the at least one driving unit,
wherein the motor includes
a stator including a plurality of stator coils repeatedly arranged in a circumferential direction; and
a rotor provided inside the stator to be rotatable about a rotating shaft, the rotor including a plurality of rotor coils interacting with the plurality of stator coils to generate rotational force,
wherein the plurality of the rotor coils are repeatedly arranged in the circumferential direction and are paired in twos to implement an N-pole or an S-pole.
